(19) United States
(12) Patent Application Publication
(10) Pub. No.: US 2013/0097349 A1
(43) Pub. Date: Apr. 18, 2013

(54) Quality of Service Arbitration Method and Quality of Service Arbiter Thereof

(71) Applicants: Kuo-Cheng Lu, Hsinchu County (TW); Chan-Shih Lin, Hsinchu County (TW)

(72) Inventors: Kuo-Cheng Lu, Hsinchu County (TW); Chan-Shih Lin, Hsinchu County (TW)

(21) Appl. No.: 13/273,232

(22) Filed: Oct. 14, 2011

(51) Int. Cl. G06F 13/37

(52) U.S. Cl. 710/122

(57) ABSTRACT

A quality of service (QoS) arbitration method for an on-chip bus is disclosed. The bus arbitration method includes steps of classifying each of a plurality of requestors into one of a plurality of first QoS types; classifying the each of the plurality of requestors into one of a plurality of second QoS types corresponding to a plurality of service priorities according to a due date or a data rate of the each of the plurality of requestors and the one of the plurality of first QoS types; and choosing a requestor with a highest service priority among the plurality of requestors to service.

### BACKGROUND OF THE INVENTION

1. Field of the Invention

The present invention relates to a quality of service (QoS) arbitration method and QoS arbiter thereof, and more particularly, to a QoS arbitration method and QoS arbiter thereof capable of providing minimum bandwidth guarantee, maximum bandwidth limitation and latency guarantee.

2. Description of the Prior Art

With the advancing of semiconductor technology, more and more peripherals are integrated into a chip for lower cost and higher performance. On-chip bus is generally adapted to connect these peripherals, i.e. requestors, together sharing the same system resources (e.g. SDRAM).

Conventionally, Strict priority (SP) arbitration, Round-robin (RR) arbitration, Weighted round-round (WRR) arbitration or Time division multiple access (TDMA) are utilized for determining which peripheral gets the system resource.

However, any of the above four methods can not provide all requirements of minimum bandwidth guarantee, maximum bandwidth limitation and latency guarantee. In order to meet the diversified bandwidth and latency requirement for each peripheral, there is a need to improve over the prior art.

### SUMMARY OF THE INVENTION

It is therefore an objective of the present invention to provide a quality of service (QoS) arbitration method and QoS arbiter thereof capable of providing minimum bandwidth guarantee, maximum bandwidth limitation and latency guarantee.

The present invention discloses a quality of service (QoS) arbitration method for an on-chip bus. The bus arbitration method includes steps of classifying each of a plurality of requestors into one of a plurality of first QoS types; classifying the each of the plurality of requestors into one of a plurality of second QoS types corresponding to a plurality of service priorities according to a due date or a data rate of the each of the plurality of requestors and the one of the plurality of first QoS types; and choosing a requestor with a highest service priority among the plurality of requestors to service.

The present invention further discloses a quality of service (QoS) arbiter for an on-chip bus. The arbiter method includes a plurality of classifiers, each for classifying each of a plurality of requestors into one of a plurality of first QoS types, and classifying the each of the plurality of requestors into one of a plurality of second QoS types corresponding to a plurality of service priorities according to a due date or a data rate of the each of the plurality of requestors and the one of the plurality of first QoS types; and a strict priority arbiter, for choosing a requestor with a highest service priority among the plurality of requestors to service.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an arbiter for an on-chip bus according to an embodiment of the present invention.

FIG. 2A is a schematic diagram of a classifier shown in FIG. 1 classifying a requestor according to an embodiment of the present invention.

FIG. 2B is a schematic diagram of an order of service priorities of a plurality of QoS types according to an embodiment of the present invention.

FIG. 3 is a schematic diagram of a look up table of a look-up table unit shown in FIG. 1 according to an embodiment of the present invention.

FIG. 4A is a schematic diagram of a simulation setup of the QoS arbiter shown in FIG. 1 according to an embodiment of the present invention.

FIG. 4B is a schematic diagram of bandwidth distributions in different cases according to an embodiment of the present invention.

FIGS. 4C-4F are schematic diagrams of cumulative distribution function to latency in the different cases according to an embodiment of the present invention.

FIG. 5 is a schematic diagram of comparisons between the QoS arbiter and the conventional methods of Strict priority arbitration, Round-robin arbitration, Weighted round-round arbitration and Time division multiple access according to an embodiment of the present invention.

FIG. 6 is a schematic diagram of a QoS arbitration process according to an embodiment of the present invention.

### DETAILED DESCRIPTION

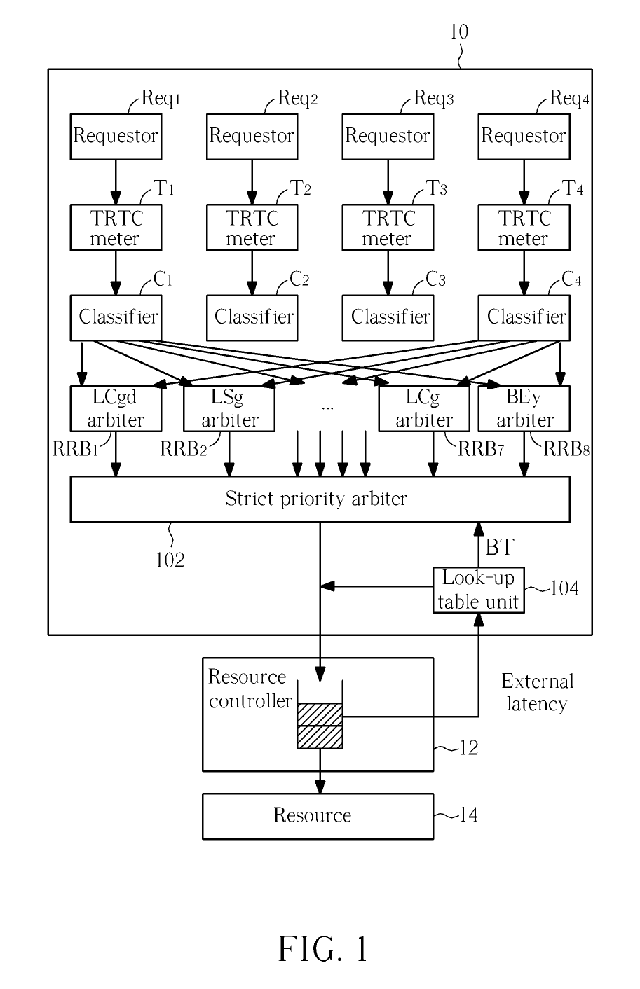

Please refer to FIG. 1, which is a schematic diagram of a QoS arbiter 10 for an on-chip bus according to an embodiment of the present invention. As shown in FIG. 1, the QoS arbiter 10 includes requestors Req₁-Req₄, two rate three color (TRTC) meters T₁-T₄, classifiers C₁-C₄, Round Robin (RR) arbiters RRB₁-RRB₈, a strict priority arbiter 102, and a look-up table unit 104. In short, a classifier Cₓ of the classifiers C₁-C₄ classifies a requestor Reqₓ of requestors Req₁-Req₄ into a QoS type FTₓ of QoS types FT₁-FT₄ first, and then classifies the requestor Reqₓ into a QoS type STₓ of QoS types ST₁-ST₈ corresponding to a plurality of service priorities according to a due date or a data rate of the requestor Reqₓ and the QoS type FTₓ. By the same token, after the classifiers C₁-C₄ classify all of the requestors Req₁-Req₄ into one of the QoS types ST₁-ST₈, respectively, the strict priority arbiter 102 chooses a requestor with a highest service priority among the requestors Req₁-Req₄ to service. As a result, the QoS arbiter 10 can provide minimum bandwidth guarantee, maximum bandwidth limitation and latency guarantee for all of the requestors Req₁-Req₄ according to QoS types due dates and data rates of the requestors Req₁-Req₄.

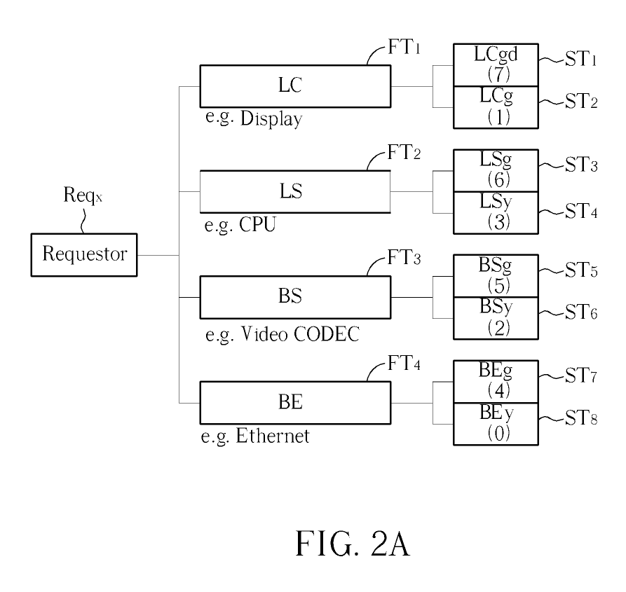

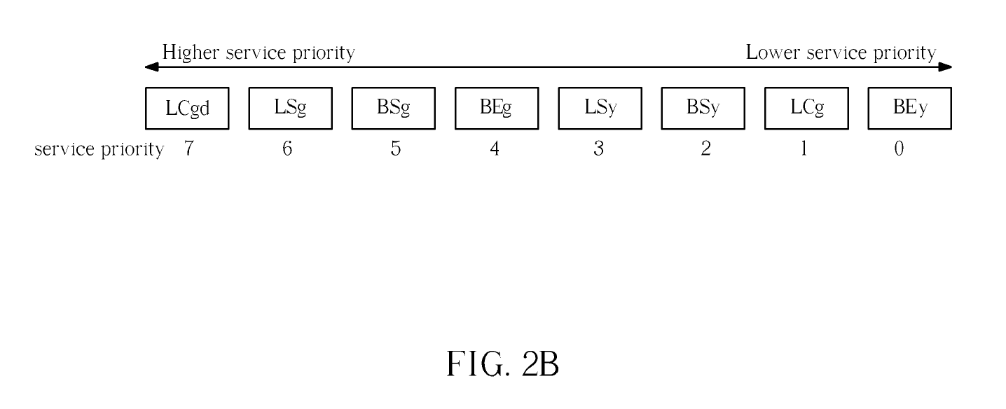

Specifically, please refer to FIG. 2A, which is a schematic diagram of the classifier Cₓ shown in FIG. 1 classifying the requestor Reqₓ according to an embodiment of the present invention. As shown in FIG. 2A, the classifier Cₓ first classifies the requestor Reqₓ into one of the QoS types FT₁-FT₄, which includes a Latency critical (LC) type FT₁, a Latency sensitive (LS) type FT₂, a Bandwidth sensitive (BS) type FT₃ and a Best effort (BE) type FT₄. The LC type FT₁ needs to meet bandwidth requirement before a specific time for normal operation, e.g. a display, the LS type FT₂ needs to meet bandwidth requirement before a specific time for timely operation, e.g. CPU, the BS type FT₃ needs to meet bandwidth requirement in a specific period for normal operation, e.g. video CODEC, and the BE type FT₄ only needs spare bandwidth, e.g. Ethernet.

Then, since the TRTC meter Tₓ meters the requestor Reqₓ to determine the due date and the data rate of the requestor Reqₓ, the classifier Cₓ can further classify the requestor Reqₓ into one of the QoS types ST₁-ST₈. For example, the classifier Cₓ classifies the requestor Reqₓ as green when the data rate is lower than a guaranteed minimum bandwidth, as yellow when the data rate is higher than the guaranteed minimum bandwidth and lower than a Maximum bandwidth limitation, and as red when the data rate is higher than the maximum bandwidth limitation. Besides, if the requestor Reqₓ is classified as the LC type FT₁, a due date counter is assigned and is down counted every clock cycle, such that the classifier Cₓ can further classify the requestor Reqₓ as due date approaching when the due date is lower than a due date limit.

Under such a situation, the classifier Cₓ can further classify the requestor Reqₓ into one of the QoS types ST₁-ST₈, which includes a LC green with due date approaching (LCgd) type ST₁, a LC green (LCg) type ST₂, a LS green (LSg) type ST₃, a LS yellow (LSy) type ST₄, a BS green (BSg) type ST₅, a BS yellow (BSy) type ST₆, a BE green (BEg) type ST₇ and a BE yellow (BEY) type ST₈, wherein service priorities of the QoS types ST₁-ST₈ from high to low (7 to 1) are the LCgd type ST₁, the LSg type ST₃, the BSg type ST₅, the BEg type ST₇, the LSy type ST₄, the BSy ST₆, the LCg type ST₂ and the BEy type ST₈ as shown in FIG. 2B. As a result, the QoS arbiter 10 can set requestor with the LCgd type ST₁ highest priority and requestors with data rates lower than respective guaranteed minimum bandwidths (green), so as to provide minimum bandwidth guarantee and latency guarantee for all of the requestors Req₁-Req₄ according to QoS types, due dates and data rates of the requestors Req₁-Req₄.

Besides, a yellow LC type and all red color requestors are not considered since the yellow LC type and all the red color requestors are blocked, i.e. a guaranteed minimum bandwidth for the LC type FT₁ is designed higher than a request bandwidth of any requestor with the LC type FT₁ and all the red color requestors already have data rate higher than a maximum bandwidth limitation. As a result, the QoS arbiter 10 can provide maximum bandwidth limitation and latency guarantee for all of the requestors Req₁-Req₄ according to QoS types, due dates and data rates of the requestors Req₁-Req₄.

Moreover, please continue to refer to FIG. 1. After the classifiers C₁-C₄ classify all of the requestors Req₁-Req₄ into one of the QoS types ST₁-ST₈ for the RR arbiters RRB₁-RRB₈, e.g. an LCgd arbiter RRB₁, an LCg arbiter RRB₂, an LSg arbiter RRB₃, an LSy arbiter RRB₄, a BSg arbiter RRB₅, a BSy arbiter RRB₆, a BEg arbiter RRB₇ and a BEY arbiter RRB₈, each of the RR arbiters RRB₁-RRB₈ arbitrates requestors with the same one of the QoS types ST₁-ST₈ by a RR scheduling, e.g. the LCgd arbiter RRB₁ arbitrates requestors with the LCgd type ST₁. Then, the strict priority arbiter 102 chooses a requestor with a highest service priority among the requestors Req₁-Req₄ to service. As a result, the requestors with the same one of the QoS types ST₁-ST₈ can be alternatively scheduled for the strict priority arbiter 102.

Noticeably, the spirit of the present invention is to classify requestors and decide respective priorities according to QoS types, due dates and data rates of the requestors, so as to provide minimum bandwidth guarantee, maximum bandwidth limitation and latency guarantee for all of the requestors. Those skilled in the art should make modifications or alterations accordingly. For example, the 4 requestors Req₁-Req₄, the 4 TRTC meters T₁-T₄, the 4 classifiers C₁-C₄, the 8 RR arbiters RRB₁-RRB₈, the 4 QoS types FT₁-FT₄ the QoS types ST₁-ST₈ and the order of the 8 service priorities thereof are only illustrated as example, and the number of components and the number of QoS types, the order of the service priorities can be modified for different requirements.

Moreover, if an external latency of a resource controller 12 is high, e.g. extra latency contributed by previous requestors in a long queue of an SDRAM controller, the strict priority arbiter 102 may choose a requestor with a highest service priority among the requestors Req₁-Req₄ but an absolute low priority to access a resource 14, e.g. an SDRAM. Under such a situation, the resource controller 12 has to process the requestor with the absolute low priority first, and thus may delay following requestors with absolute high priorities. Therefore, the strict priority arbiter 102 can mask requestors with service priorities lower than a blocking threshold BT. As a result, the QoS arbiter 10 can provide better QoS for requestors with higher priorities, e.g. requestors with the LCgd type ST₁ and the LSg type ST₃,

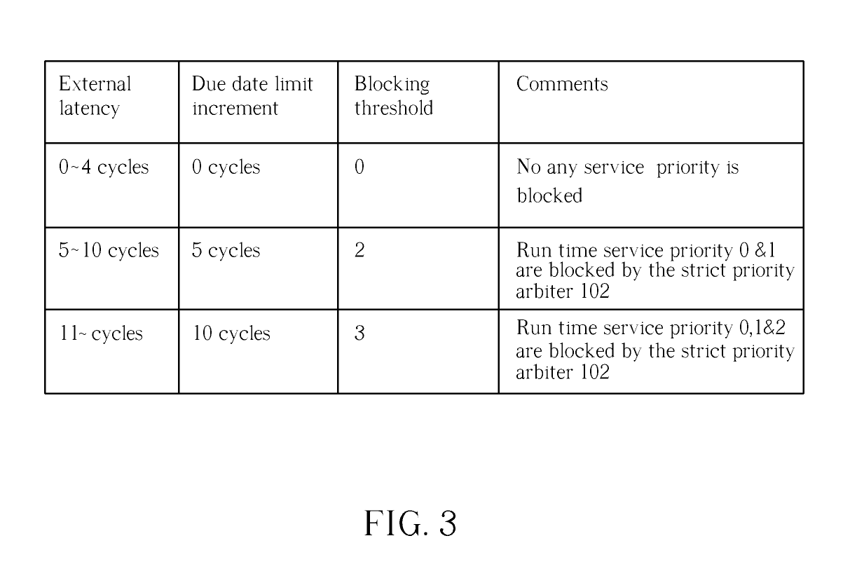

Furthermore, the QoS arbiter 10 can further include the look-up table unit 104 for adjusting the due date limit and the blocking threshold BT according to the external latency of the resource controller 12. For example, please refer to FIG. 3, which is a schematic diagram of a look-up table of the look-up table unit 104 shown in FIG. 1 according to an embodiment of the present invention. As shown in FIG. 3, when the external latency of the resource controller 12 increases, both the due date limit and the blocking threshold BT increase. As a result, the LC type FT₁ will be classified as the LCgd type ST₁ earlier to avoid being delayed in the resource controller 12, and the requestors with absolute high priorities are not delayed when the external latency of the resource controller 12 is high.

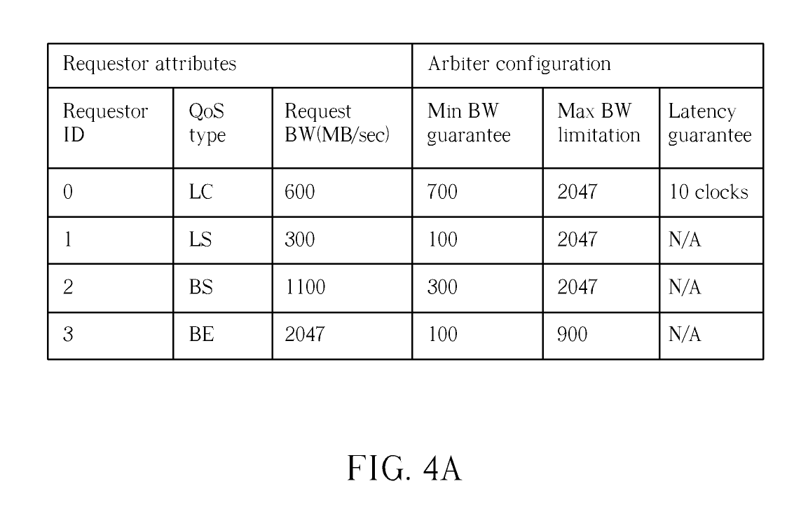

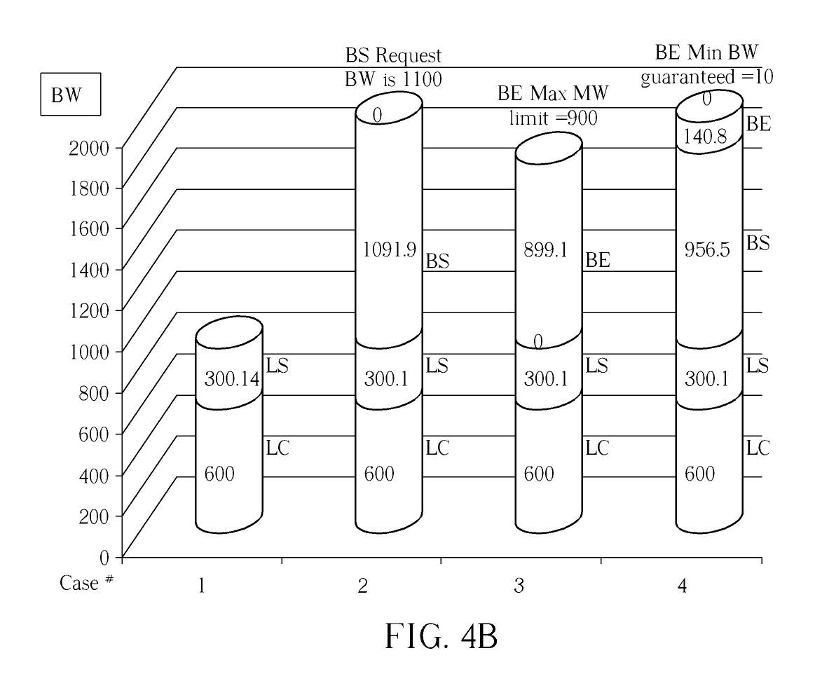

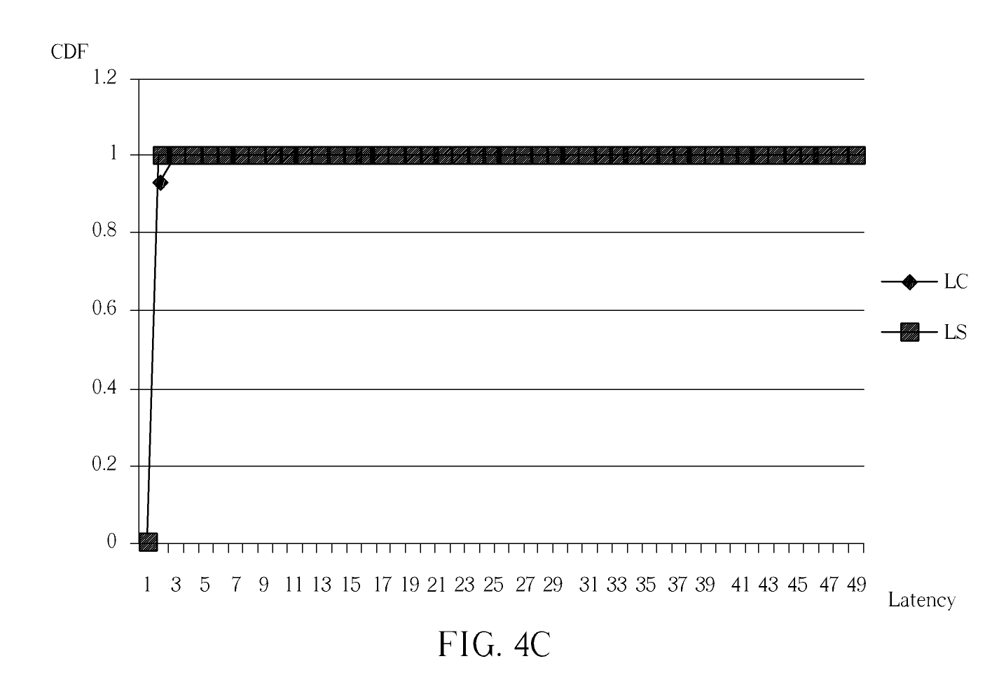

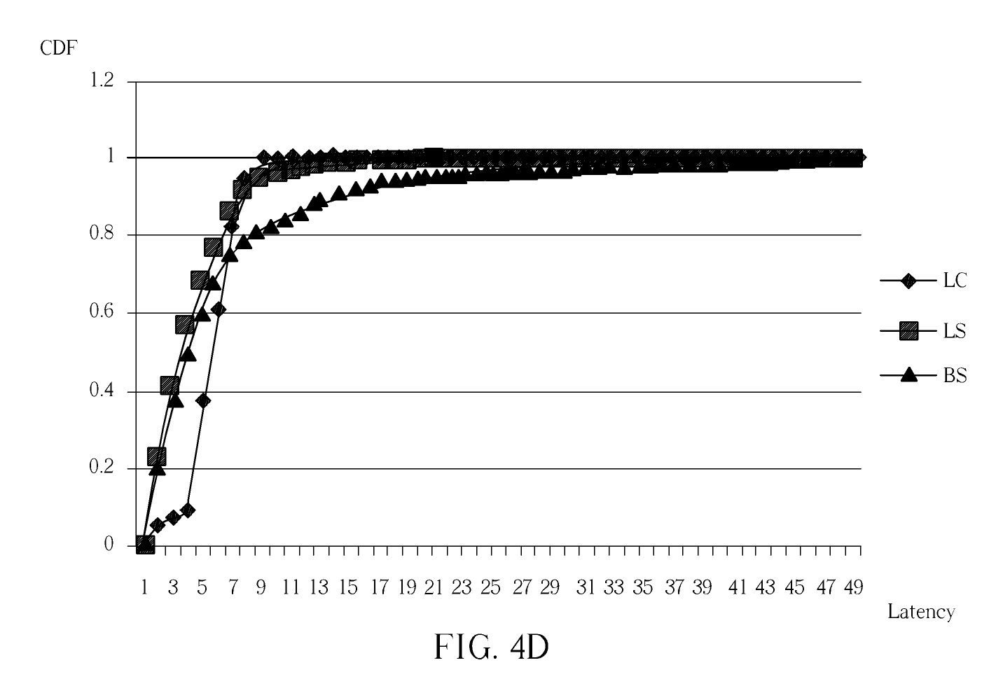

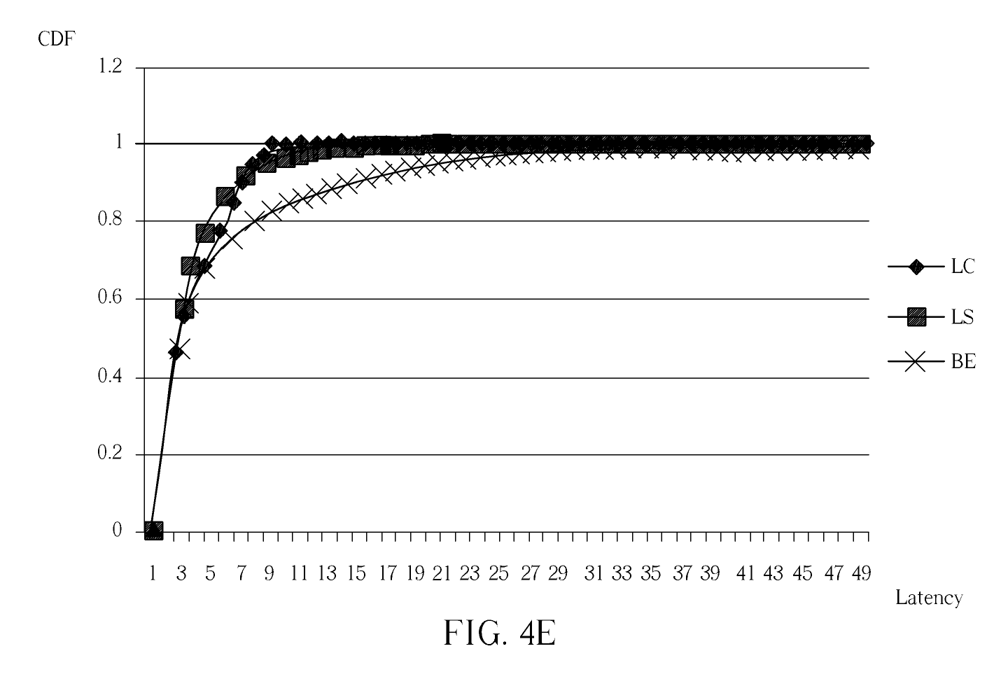

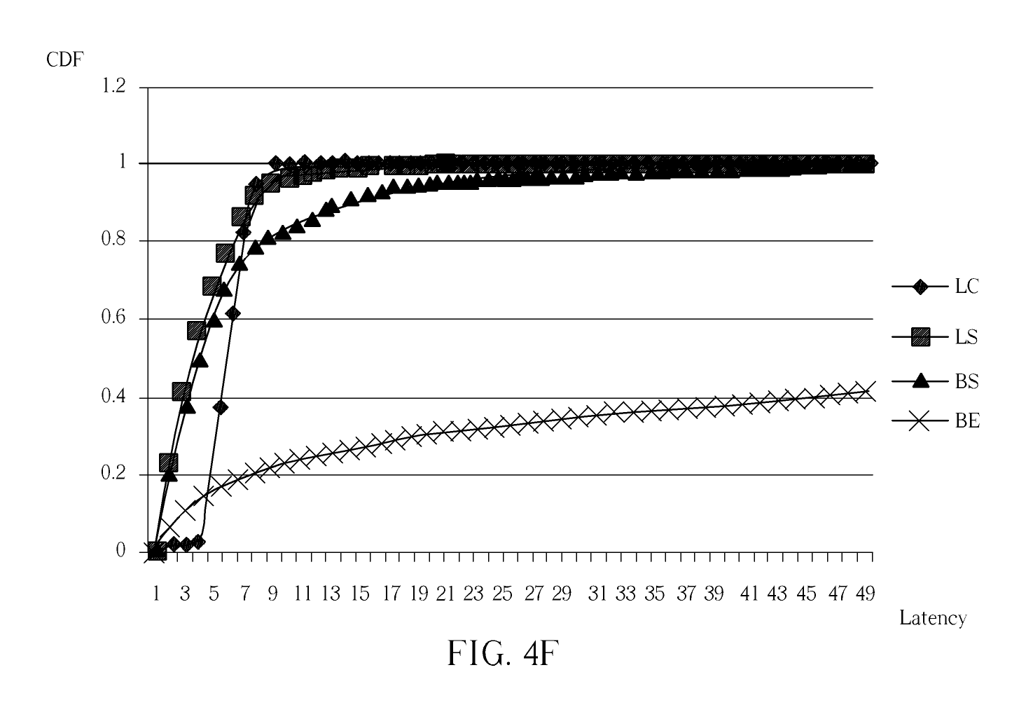

For simulation results, please refer to FIG. 4A-4F. FIG. 4A is a schematic diagram of a simulation setup of the QoS arbiter 10 shown in FIG. 1 according to an embodiment of the present invention, and FIG. 4B is a schematic diagram of bandwidth (BW) distributions indifferent cases according to an embodiment of the present invention, and FIGS. 4C-4F are schematic diagrams of cumulative distribution function (CDF) to latency in the different cases according to an embodiment of the present invention, wherein a CDF indicates a percentage of request bandwidth already granted. As shown in FIG. 4A-4C, in case 1, a requestor 1 with the LC type FT₁ and a requestor 2 with the LS type FT₂ are introduced. Under such a situation, since a total request bandwidth is far lower than a maximum (Max) bandwidth limitation of the on-chip bus, i.e. 600+300=900<2047, both the requestor 1 and the requestor 2 can get respective request bandwidths quickly. Noticeably, since service priorities of the LSg type ST₃ and the LSy type ST₄ are higher than the LCg type ST₂, i.e. 6, 3>1, the requestor 1 with the LC type FT₁ gets request bandwidth earlier than the requestor 2 with the LS type FT₂.

As shown in FIGS. 4A-4B, 4D, in case 2, the requestor 1 with the LC type FT₁, the requestor 2 with the LS type FT₂ and a requestor 3 with the BS type FT₃ are introduced. Under such a situation, since a total request bandwidth is approximate to a maximum (Max) bandwidth limitation of the on-chip bus, i.e. 600+300<2047, both the requestor 1, the requestor 2 and the requestor 3 can get respective request bandwidths. Specifically, since the service priority of the LCgd type ST₁ is highest and service priorities of the LSg type ST₃ and the BSg type ST₅ are higher than the LCg type ST₂, i.e. 7>6>5>1, the requestor 2 with the LS type FT₂ and the requestor 3 with the BS type FT₃ get more bandwidth than the requestor 1 with the LC type FT₁ before a due date of the requestor 1 with the LC type FT₁ approaches. After the due date of the requestor 1 with the LC type FT₁ is lower than a due date limit, e.g. 5, the requestor 1 with the LC type FT₁ has a highest priority to get bandwidth. Therefore, the requestor 1 with the LC type FT₁, the requestor 2 with the LS type FT₂ and the requestor 3 with the BS type FT₃ sequentially get respective request bandwidths when the total request bandwidth is approximate to the maximum (Max) bandwidth limitation.

As shown in FIGS. 4A-4B, 4E, in case 3, the requestor 1 with the LC type FT₁, the requestor 2 with the LS type FT₂ and a requestor 4 with the BE type FT₄ are introduced. Under such a situation, a request bandwidth of the requestor 4 is higher than a maximum bandwidth limitation of the BE type FT₄, the QoS arbiter 10 can only provide the maximum bandwidth limitation to the requestor 4 at most. Since a total grantable request bandwidth is lower than a maximum (Max) bandwidth limitation of the on-chip bus, i.e. 600+300+900=1800<2047, both the requestor 1, the requestor 2 can get respective request bandwidths while the requestor 4 gets the maximum bandwidth limitation rather than the request bandwidth. Specifically, since the service priority of the LCgd type ST₁ is highest and service priorities of the LSg type ST₃ and the BEg type ST₇ are higher than the LCg type ST₂, i.e. 7>6>4>1, the requestor 2 with the LS type FT₂ and the requestor 4 with the BE type FT₄ gets more bandwidth than the requestor 1 with the LC type FT₁ before the due date of the requestor 1 with the LC type FT₁ approaches. After the due date of the requestor 1 with the LC type FT₁ is lower than the due date limit, e.g. 5, the requestor 1 with the LC type FT₁ has a highest priority to get bandwidth. Therefore, the requestor 1 with the LC type FT₁ and the requestor 2 with the LS type FT₂ sequentially get respective request bandwidths while the requestor 4 with the BE type FT₄ only gets the defined maximum bandwidth limitation when total grantable request bandwidth is lower than a maximum (Max) bandwidth limitation.

As shown in FIGS. 4A-4B, 4F, in case 4, the requestor 1 with the LC type FT₁, the requestor 2 with the LS type FT₂ the requestor 3 with the BS type FT₃ and the requestor 4 with the BE type FT₄ are introduced. Under such a situation, a request bandwidth of the requestor 4 is higher than a maximum bandwidth limitation of the BE type FT₄, the QoS arbiter 10 can only provide the maximum bandwidth limitation to the requestor 4 at most. Since a total grantable request bandwidth is higher than a maximum (Max) bandwidth limitation of the on-chip bus, i.e. 600+300++1100+900=2900<2047, both the requestor 1, the requestor 2 can get respective request bandwidths while the requestor 3 almost gets the request bandwidth and the requestor 4 gets spare bandwidth. Specifically, since the service priority of the LCgd type ST₁ is highest and service priorities of the LSg type ST₃, the BSg type ST₅ and the BEg type ST₇ are higher than the LCg type ST₂, i.e. 7>6>5>4>1, the requestor 2 with the LS type FT₂, the requestor 3 with the BS type FT₃ and the requestor 4 with the BE type FT₄ get more bandwidth than the requestor 1 with the LC type FT₁ before the due date of the requestor 1 with the LC type FT₁ approaches. After the due date of the requestor 1 with the LC type FT₁ is lower than the due date limit, e.g. 5, the requestor 1 with the LC type FT₁ has a highest priority to get bandwidth. Therefore, the requestor 1 with the LC type FT₁ and the requestor 2 with the LS type FT₂ sequentially get respective request bandwidths while the requestor 3 almost gets the request bandwidth and the requestor 4 gets spare bandwidth when the total grantable request bandwidth is higher than a maximum (Max) bandwidth limitation.

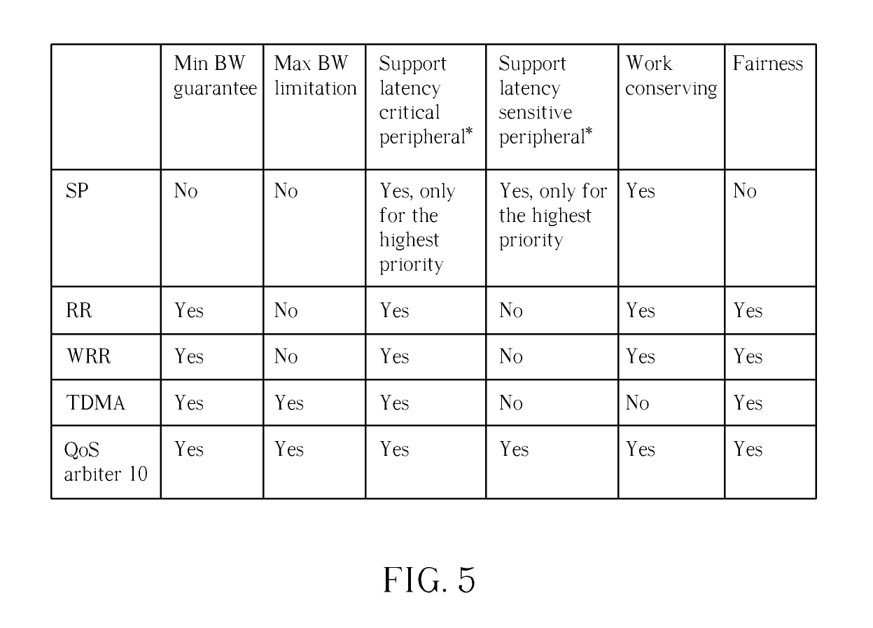

In addition, please refer to FIG. 5, which is a schematic diagram of comparisons between the QoS arbiter 10 and the conventional methods of Strict priority (SP) arbitration, Round-robin (RR) arbitration, Weighted round-round (WRR) arbitration and Time division multiple access (TDMA). As shown in FIG. 5, only the QoS arbiter 10 can provide minimum bandwidth guarantee, maximum bandwidth limitation and latency guarantee, and can further reduce the latency variation seen by latency critical or latency sensitive peripherals with the Max bandwidth limitation feature.

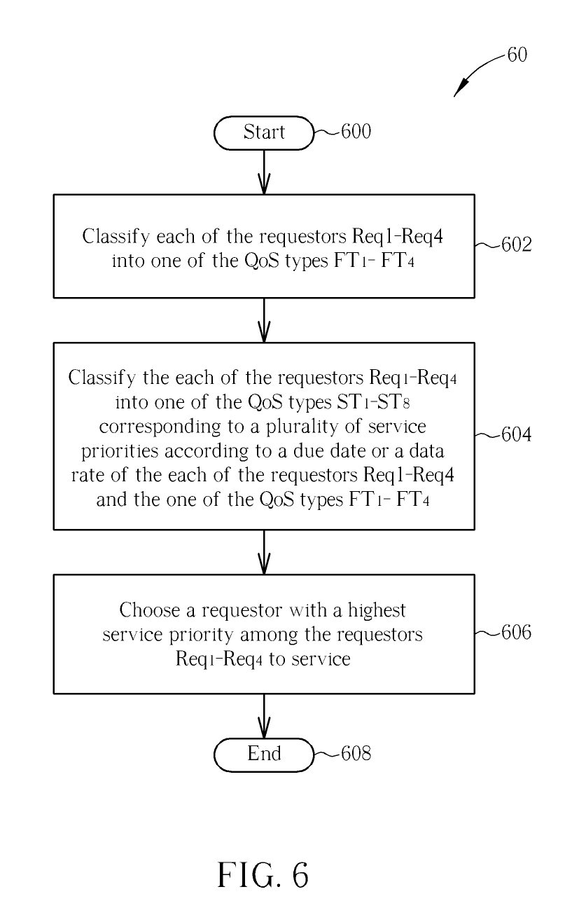

Operations of the QoS arbiter 10 can be summarized into a QoS arbitration process 60 as shown in FIG. 6. The QoS arbitration process includes following steps:

Step 600: Start.

Step 602: Classify each of the requestors Req₁-Req₄ into one of the QoS types FT₁-FT₄.

Step 604: Classify the each of the requestors Req₁-Req₄ into one of the QoS types ST₁-ST₈ corresponding to a plurality of service priorities according to a due date or a data rate of the each of the requestors Req₁-Req₄ and the one of the QoS types FT₁-FT₄.

Step 606: Choose a requestor with a highest service priority among the requestors Req₁-Req₄ to service.

Step 608: End.

Details of the QoS arbitration process 60 can be derived by referring to the above descriptions.

In the prior art, any of Strict priority (SP) arbitration, Round-robin (RR) arbitration, Weighted round-round (WRR) arbitration or Time division multiple access (TDMA) can not provide all requirements of minimum bandwidth guarantee, maximum bandwidth limitation and latency guarantee. In comparison, the present invention classifies requestors and decides respective priorities according to QoS types, due dates and data rates of the requestors, so as to provide minimum bandwidth guarantee, maximum bandwidth limitation and latency guarantee for all of the requestors.

Those skilled in the art will readily observe that numerous modifications and alterations of the device and method may be made while retaining the teachings of the invention.

What is claimed is:

1. A quality of service (QoS) arbitration method for an on-chip bus, the QoS arbitration method comprising:
classifying each of a plurality of requestors into one of a plurality of first QoS types;
classifying the each of the plurality of requestors into one of a plurality of second QoS types corresponding to a plurality of service priorities according to a due date or a data rate of the each of the plurality of requestors and the one of the plurality of first QoS types; and
choosing a requestor with a highest service priority among the plurality of requestors to service.

2. The QoS arbitration method of claim 1, wherein the plurality of first QoS types comprise a Latency critical (LC) type, a Latency sensitive (LS) type, a Bandwidth sensitive (BS) type and a Best effort (BE) type.

3. The QoS arbitration method of claim 1 further comprising classifying the each of the plurality of requestors as green when the data rate is lower than a guaranteed minimum bandwidth, as yellow when the data rate is higher than the guaranteed minimum bandwidth and lower than a Maximum bandwidth limitation, and as red when the data rate is higher than the maximum bandwidth limitation.

4. The QoS arbitration method of claim 3, wherein the each of the plurality of requestors is classified as due date approaching when the due date is lower than a due date limit.

5. The QoS arbitration method of claim 4, wherein the plurality of second QoS types comprise a LC green with due date approaching (LCgd) type, a LC green (LCg) type, a LS green (LSg) type, a LS yellow (LSy) type, a BS green (BSg) type, a BS yellow (BSy) type, a BE green (BEg) type and a BE yellow (BEY) type.

6. The QoS arbitration method of claim 5, wherein service priorities of the plurality of second QoS types from high to low are the LCgd type, the LSg type, the BSg, the BEg type, the LSy type, the BSy, the LCg type and the BEy type.

7. The QoS arbitration method of claim 1 further comprising:
arbitrating requestors with a same one of the plurality of second QoS types by a Round Robin arbitration.

8. The QoS arbitration method of claim 1 further comprising:
masking requestors with service priorities lower than a blocking threshold.

9. The QoS arbitration method of claim 1 further comprising:
adjusting a due date limit and a blocking threshold according to an external latency of a resource controller.

10. A quality of service (QoS) arbiter, comprising:
a plurality of classifiers, each for classifying each of a plurality of requestors into one of a plurality of first QoS types, and classifying the each of the plurality of requestors into one of a plurality of second QoS types corresponding to a plurality of service priorities according to a due date or a data rate of the each of the plurality of requestors and the one of the plurality of first QoS types; and
a strict priority arbiter, for choosing a requestor with a highest service priority among the plurality of requestors to service.

11. The QoS arbiter of claim 10, wherein the plurality of first QoS types comprise a Latency critical (LC) type, a Latency sensitive (LS) type, a Bandwidth sensitive (BS) type and a Best effort (BE) type.

12. The QoS arbiter of claim 10, wherein the each classifier classifies the each of the plurality of requestors as green when the data rate is lower than a guaranteed minimum bandwidth, as yellow when the data rate is higher than the guaranteed minimum bandwidth and lower than a Maximum bandwidth limitation, and as red when the data rate is higher than the maximum bandwidth limitation.

13. The QoS arbiter of claim 12, wherein the each classifier classifies the each of the plurality of requestors as due date approaching when the due date is lower than a due date limit.

14. The QoS arbiter of claim 13, wherein the plurality of second QoS types comprise a LC green with due date approaching (LCgd) type, a LC green (LCg) type, a LS green (LSg) type, a LS yellow (LSy) type, a BS green (BSg) type, a BS yellow (BSy) type, a BE green (BEg) type and a BE yellow (BEY) type.

15. The QoS arbiter of claim 14, wherein service priorities of the plurality of second QoS types from high to low are the LCgd type, the LSg type, the BSg, the BEg type, the LSy type, the BSy, the LCg type and the BEy type.

16. The QoS arbiter of claim 10 further comprising a plurality of Round Robin (RR) arbiters, each for arbitrating requestors with a same one of the plurality of second QoS types by a RR scheduling.

17. The QoS arbiter of claim 10, wherein the strict priority arbiter masks requestors with service priorities lower than a blocking threshold.

18. The QoS arbiter of claim 10 further comprising a look-up table unit, for adjusting a due date limit and a blocking threshold according to an external latency of a resource controller.
